(19) United States
(12) Patent Application Publication
(10) Pub. No.: US 2003/0051410 A1
(43) Pub. Date: Mar. 20, 2003

(54) Display structure

(76) Inventor: Hermel R. Cloutier, Barrie (CA)

Correspondence Address: John C. McMahon, P.O. Box 30069, Kansas City, MO, 64112, US

(21) Appl. No.: 10/230,508

(22) Filed: Aug. 29, 2002

(30) Foreign Application Priority Data
Aug. 31, 2001 (CA) 2,356,417

(51) Int. Cl. E05F 3/00

(52) U.S. Cl. 49/322

(57) ABSTRACT

A vertically extensible mechanism for controlling displacement of a panel such as an advertising sign, moves the structure between vertically spaced raised and lowered positions. The mechanism comprises a pair of vertically oriented laterally spaced guide tracks each having two or more elongate track sections that are telescopically extensible. The panel is carried in a vertical orientation between the guide tracks which are anchored to a mounting to extend vertically thereon. The mounting can be an elevated one, e.g. in a roof structure, or in a building wall above a door opening, or a low level mounting, e.g. on a ground surface or floor. In an alternative arrangement that is particularly suitable for the provision of elevated display signs and banners, the guide tracks are dispensed with and the panel is supported on a plurality of flexible straps or the like which are wound around a shaft extending horizontally at an elevated location. Rotation of the shaft in one direction is effective to lower the panel and rotation in the reverse direction is effective to raise the panel. The shaft can be driven remotely, and for use with flexible panels a tensioning mechanism is provided to ensure that the panel when raised and deployed is in a tautly stretched condition.

### BACKGROUND OF THE INVENTION

a) Field of the Invention

This invention relates to a new or improved vertically extensible mechanism for controlled displacement of a panel structure such as advertising and display signs or doors between vertically spaced deployed and retracted positions.

b) Description of the Prior Art

Advertising and display signs are known in many different forms. Generally, the advertiser will wish his sign to be displayed in a prominent position, which as far as outdoor signs are concerned generally means an elevated position. Thus typically advertising signs appear on billboards, trestles, and the sides and roofs of buildings.

A difficulty arises with such advertising signs however, in that once they have been installed, they are not easily changed or replaced.

The present invention aims to provide a display structure which can be used for advertisements, signs and other purposes which is designed to deploy the advertisement or display at an elevated location and yet can accommodate easy change or replacement of the advertisement or display without the need for steps, ladders, hoists, or the like to move workers to the elevated position of the display. On the contrary, the present invention can provide a display structure wherein the advertisement or display sign is deployed in use at an elevated location, the structure providing means for lowering the advertisement to ground level when it is to be changed or replaced.

The disclosed structure also has utility in providing a mounting arrangement for other moveable panels such as overhead doors and the like. In one application the disclosed mechanism can be used to provide an overhead door for use as a so-called dock door in warehouses. Trucks and tractor trailers making deliveries and pick-ups from the warehouse are backed up to the dock door and goods are transferred to and from the warehouse by means of load-handling vehicles such as forklift trucks which can be driven into the truck body. The vertical guide tracks at the sides of the doorway for the overhead doors typically used in this application are very easily damaged through impact by the load-handling vehicles, to the extent that the door can be rendered unsafe to operate or even unserviceable. The structure disclosed herein can be used to provide an overhead door in such installations in which this problem is obviated since there is no fixed guide track at the sides of the doorway at all, but rather there is a retractable guide track at each side which is moved upwardly out of the doorway when the door is opened.

### SUMMARY OF THE INVENTION

The invention provides a display structure comprising a panel carrier and a mechanism for controlled displacement of said panel carrier between vertically spaced extended and retracted positions, said mechanism comprising a raise/lower drive system for mounting on a support at an elevated location; elongate flexible restraints connected to said drive system, and also connected to said panel carrier at laterally spaced locations thereon, said drive system being controllable selectively to retract or pay out said elongate flexible restraints to effect movement of said panel carrier between said deployed and retracted positions; a panel display frame for mounting on said support at an elevated location and configured to receive said panel carrier in the retracted position thereof and to display a panel supported on the panel carrier.

The invention also provides a display structure comprising a panel carrier and a vertically extensible mechanism for controlled displacement of the panel carrier between vertically spaced raised and lowered positions, comprising: a pair of guide tracks each formed by at least first and second elongate linear track sections, each first track section being telescopically extensible with respect to the corresponding second track section; said panel carrier being positioned in a vertically orientation between said extensible first track sections; each said guide track being adapted for anchoring to a support to extend vertically thereon for guidance of said first track sections during movement of said panel carrier between the raised and the lowered positions.

The display structure can include a flexible display panel connected to the panel support and include an elongate horizontal lower frame member for attachment to the lower edge of the flexible panel. The lower frame member preferably has projecting end sections that cooperate with spring loaded elements in the panel display frame so as to provide a vertical stretching force to the display panel as it approaches the raised retracted position.

The panel carrier and also the lower frame member may suitably each comprise an elongate horizontal beam of constant profile, e.g. fabricated in aluminium or an aluminium alloy. The beam has a profile that includes a keyhole slot having a narrow entrance portion to accommodate the thickness of the panel and a widened interior portion sized to receive an enlarged marginal edge region of the panel. For example each of the upper and lower edges of the panel may be fixed as by bonding or welding to a generally cylindrical plastic member which is sized to be introduced longitudinally into the enlarged part of the keyhole slot but which is much too large to pass through the narrow entrance portion of the keyhole slot.

Preferably the two horizontally spaced guide tracks are attached to opposite ends of the panel carrier, each track comprising two or more straight track sections that are telescopically extensible/retractable. The track sections preferably have complementary profiles and have parts that are in sliding engagement with each other. The complementary sliding parts may be of plastic, aluminimum, or other suitable materials which can slide with relatively little frictional resistance. Since the loading imposed by the weight of the panel structure acts essentially in the longitudinal direction of the track sections, i.e. vertically, lateral loading of the track sections is minimal, and therefore there is no need to include rollers to achieve smooth sliding engagement between the cooperating track sections.

The display structure of the invention is especially suitable for providing a mechanism for displaying an advertising panel or publicity banner in an elevated location e.g. on the side of a building, or on a free-standing support. In this case the panel structure comprises a framework that is carried between the laterally spaced guide tracks, the framework being adapted for attachment thereto of an advertising panel, or other display. The arrangement is particularly well suited to supporting flexible advertisement sheets or displays since the framework can be adapted to tension the panel slightly to maintain it in a taut vertical orientation. In this application the deployed position of the mechanism is with the guide track sections retracted so that the panel or the like is supported between them is displayed at an elevated position on the mounting structure. When it is time to remove or replace the panel, it is simply necessary to extend the mechanism to bring the panel close to the ground surface where it may be readily removed and replaced by an operative who has no need for ladders or other specialized equipment.

The display structure preferably includes a vertically oriented frame for mounting on the vertical support surface, the frame defining a vertical pocket having an open ended lower side into which the display banner is movable vertically. The sides and horizontal upper parts of the frame have flanges or the like which overlie and screen the guide tracks in the vertical and upper edges of the panel carrier. Vertical movement of the panel carrier on the extensible tracks is effected by a powered drive, in the preferred embodiment this comprising a driven shaft that is mounted horizontally in the upper frame member and which is connected to the panel carrier through cables connected through the opposite ends of the latter. Rotation of the shaft in one direction permits the panel carrier to descend under the force of gravity, and rotation of the shaft in the opposite direction causes the panel carrier to rise. Power may be supplied by an electric motor or the like within the shaft, and by this means the panel carrier can readily be moved between its elevated display position and its lowered position adjacent to the grounds surface.

The display structure is also susceptible of application in providing displays or advertising panels in a free-standing manner. In this application the track sections anchored to the mounting are fixed vertically at ground level. In the retracted position the panel or display is therefore at ground level, but can be raised to a selected height by extension of the track structure. In all applications the track structure can include two or more extensible track sections. In ground mounted arrangements as described, it is necessary to include a cable and pulley structure or other electrical or hydraulic drive means to effect upwards extension of the track sections.

For a door installation the panel structure is a vertically movable door carried between guide tracks which are anchored to a wall or other elevated support above the doorway. The telescopically extensible track sections provide guideways for the door in moving between its retracted (raised) position wherein the doorway is open and its deployed (lowered) position wherein the doorway is closed. It will be understood therefore that when the door is in the raised position the doorway is totally unimpeded, and in particular there are no door guide tracks at the sides of the doorway in a position where they would be vulnerable to impact. Thus applicant's vertically extensible mechanism provides a structure that is eminently well suited for the provision of dock doors, completely obviating the problems as discussed above in relation to prior art dock doors.

Whereas in most applications whether for doors or advertising signs or displays it will be preferable to employ a pair of guide tracks positioned at opposite ends of the panel, in principle there is no reason why one could not use a single centrally mounted guide track, or a pair of guide tracks positioned at intermediate locations in the length of the panel.

The invention will further be described, by way of example only, with reference to the accompanying drawings wherein:

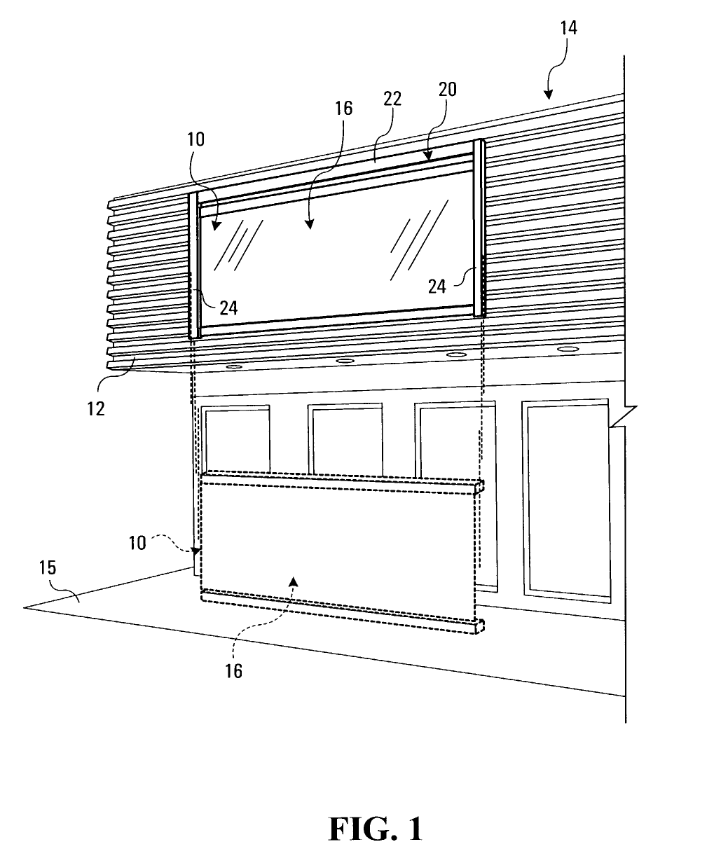

FIG. 1 is a somewhat schematic perspective view showing one embodiment of the display structure as mounted on a building wall;

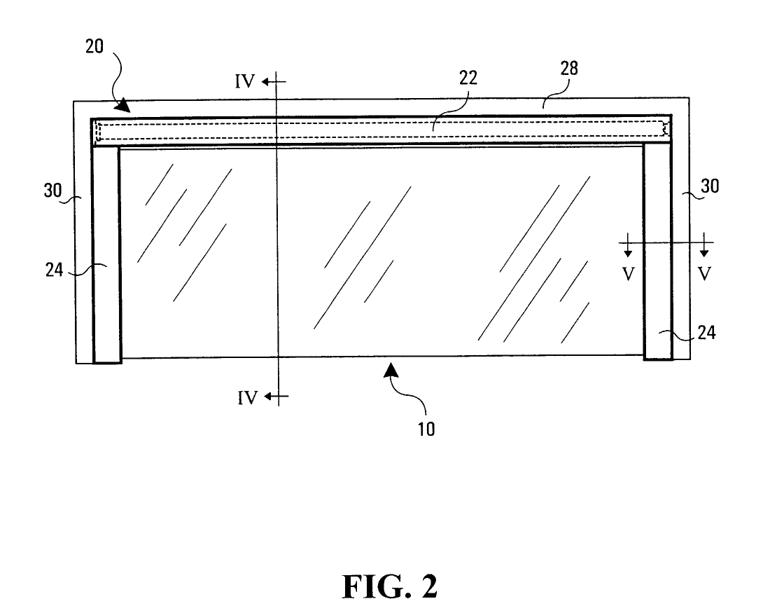

FIG. 2 is a front elevation of the display structure drawn to a somewhat enlarged scale;

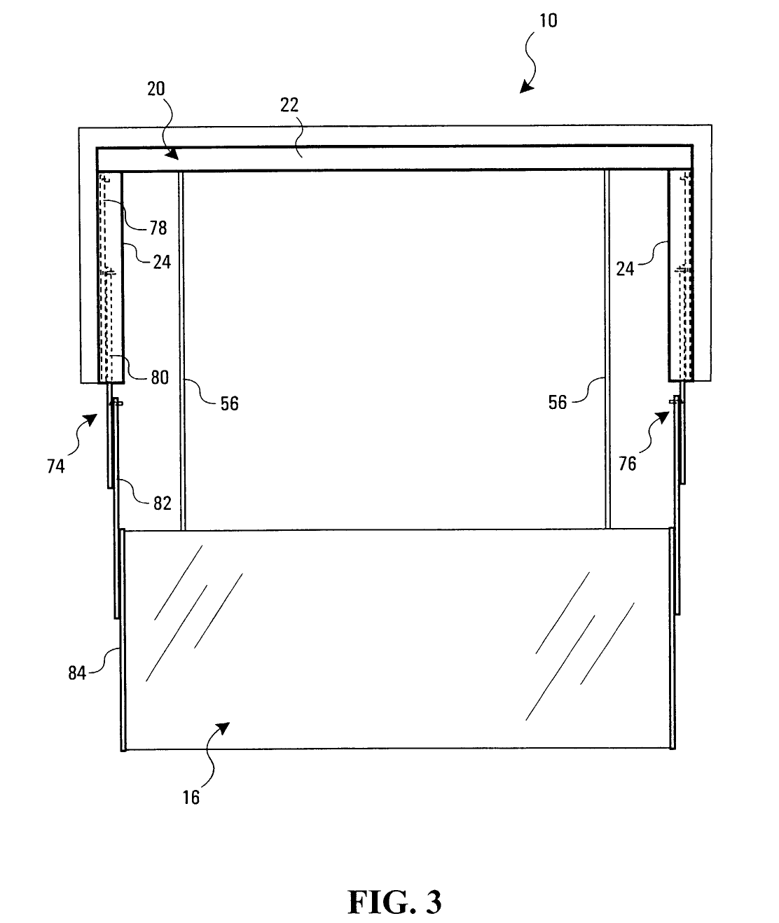

FIG. 3 is a view similar to FIG. 2 but showing the display structure in an intermediate lowered or extended condition;

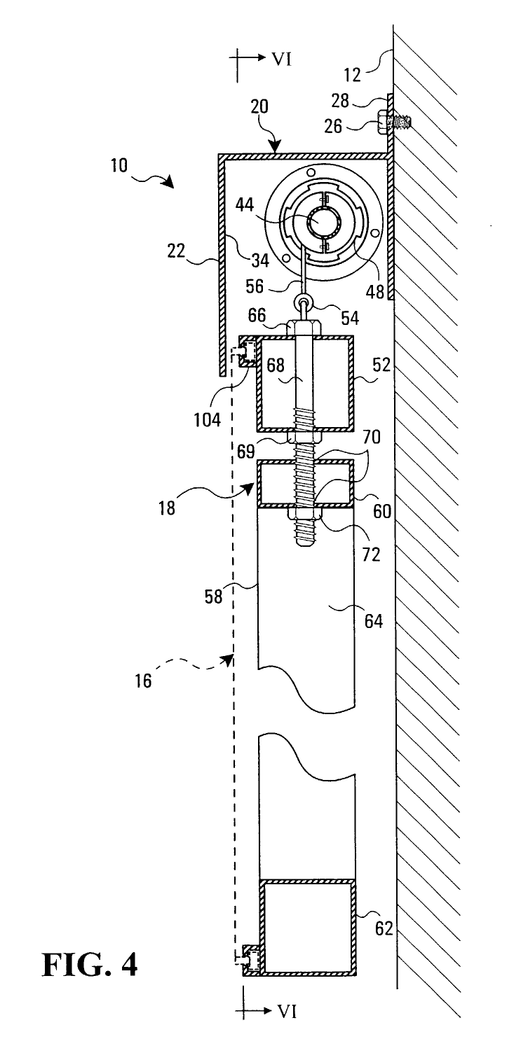

FIG. 4 is a vertical sectional view to an enlarged scale taken on the line IV-IV in FIG. 2;

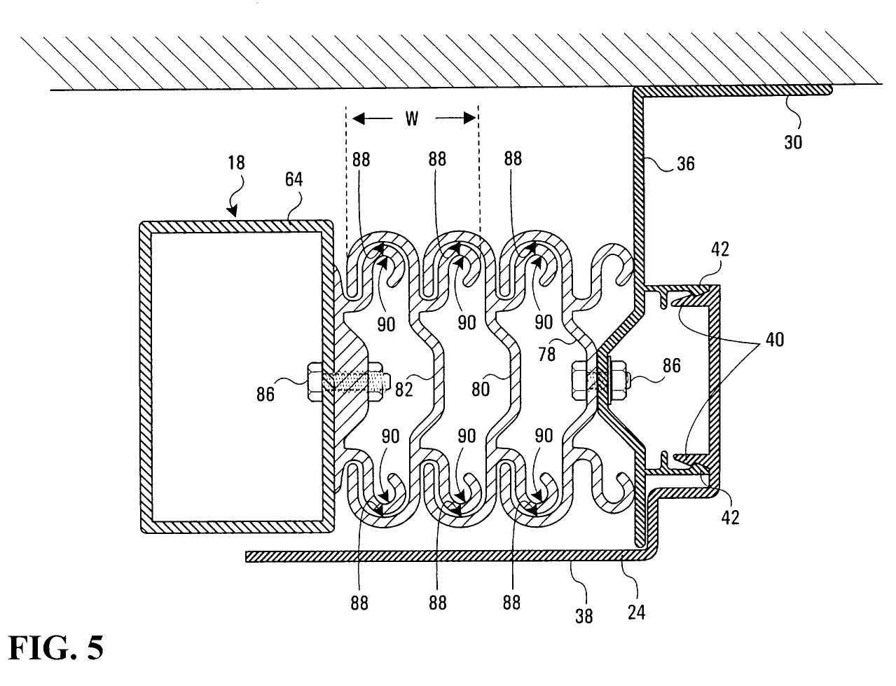

FIG. 5 is an enlarged horizontal sectional view taken on the line V-V in FIG. 2;

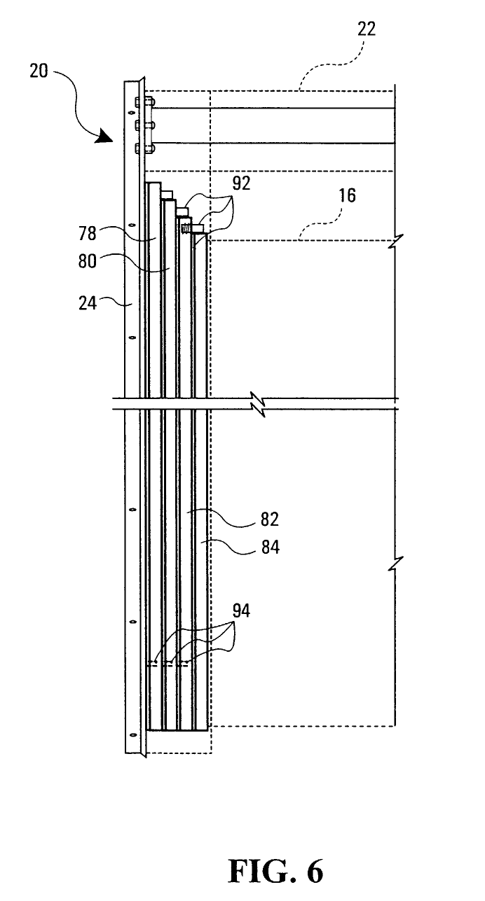

FIG. 6 is a fragmentary view taken on the line VI-VI of FIG. 4;

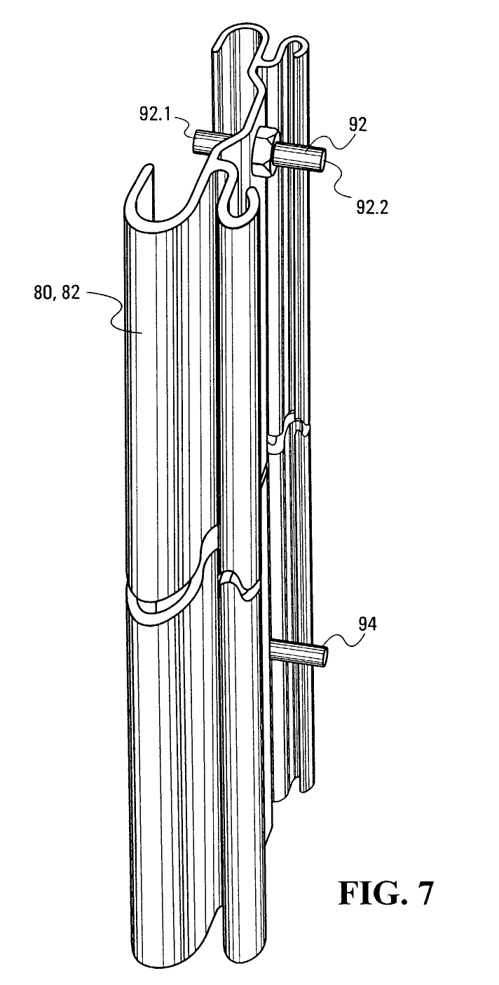

FIG. 7 is a somewhat schematic foreshortened view showing a section of an extendible track incorporated in the structure;

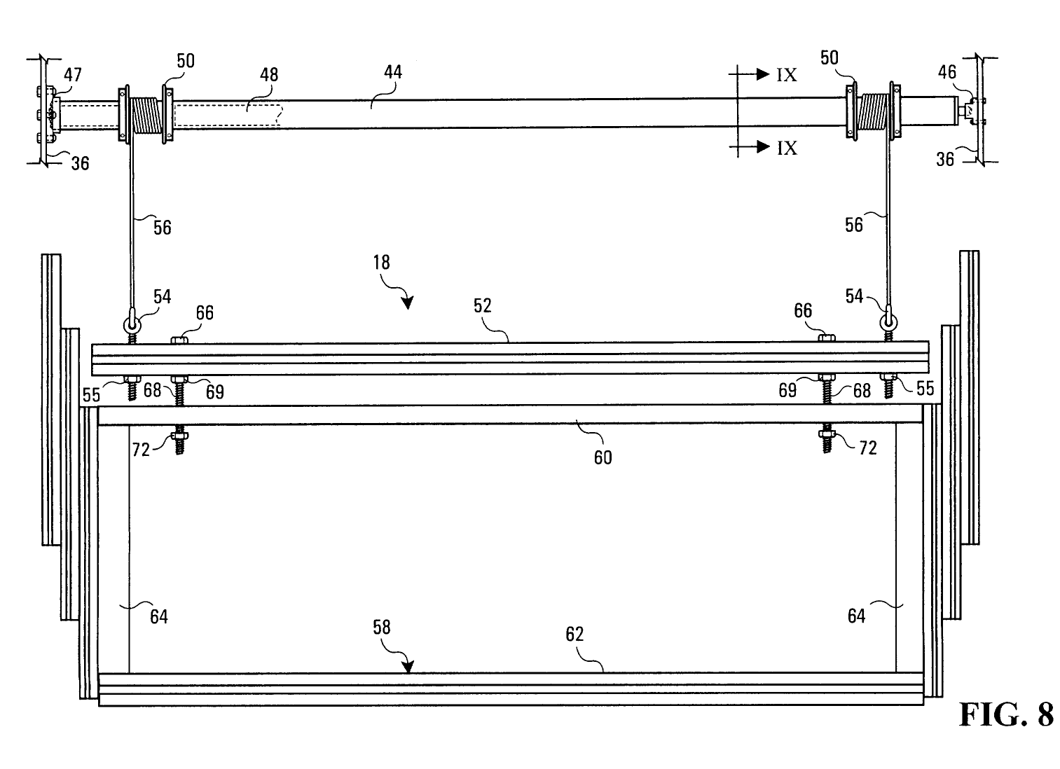

FIG. 8 is an enlarged view corresponding to FIG. 3 with portions omitted to show a more detailed arrangement of the panel carrier;

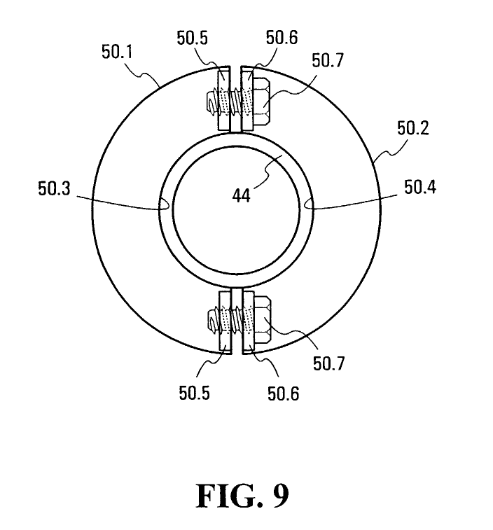

FIG. 9 is an enlarged cross-sectional view taken on the line IX-IX in FIG. 8;

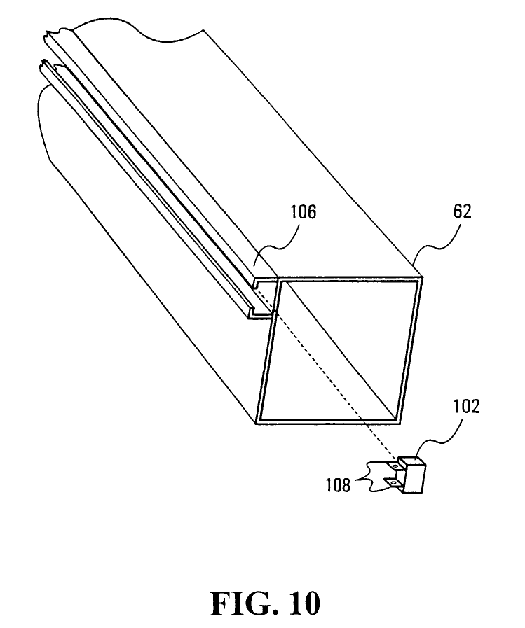

FIG. 10 is an enlarged fragmentary perspective view showing a means for attachment of a panel to said panel carrier;

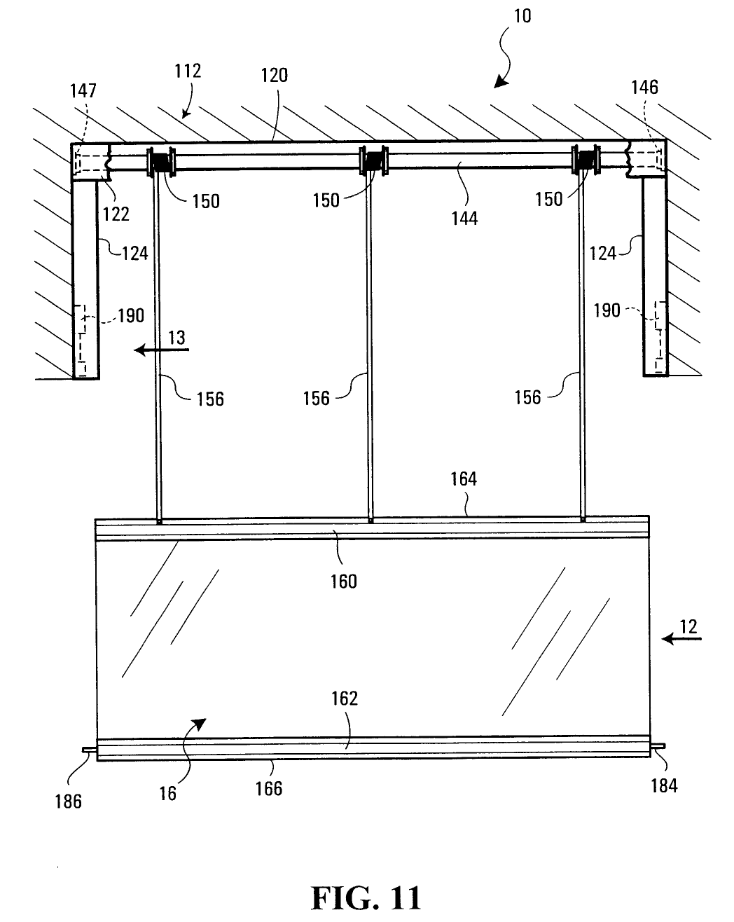

FIG. 11 is a view similar to FIG. 2 showing a preferred modified version of the display structure embodying the invention;

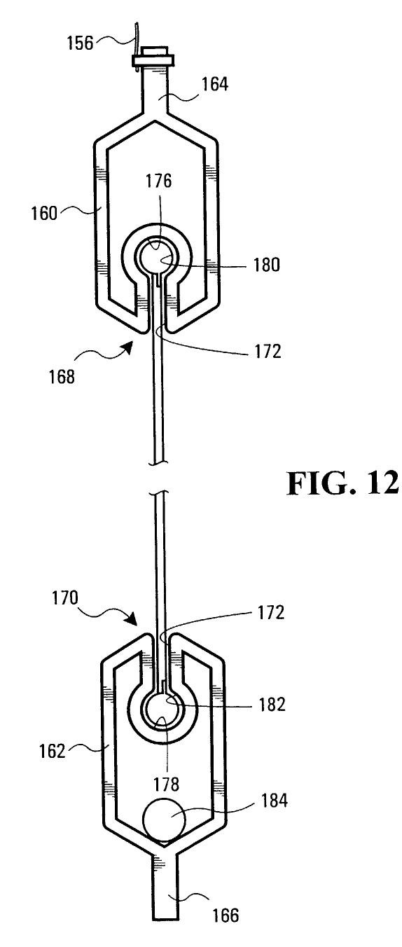

FIG. 12 is an enlarged view taken in the direction of the arrow 12 in FIG. 11; and

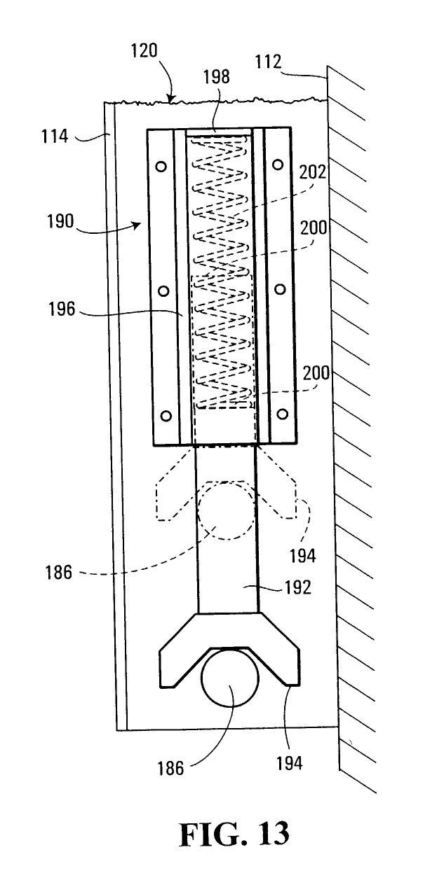

FIG. 13 is an enlarged view taken in the direction of the arrow 13 in FIG. 11.

### DESCRIPTION OF THE PREFERRED EMBODIMENTS

As seen in FIG. 1, the display structure 10 is mounted on the front wall 12 of a building 14 and is movable from an elevated position (shown in full lines) to a lowered position (shown in broken lines), in the lowered position the display structure being accessible from a ground surface 15. As will be more clearly described hereinafter, at the lowered position shown in broken lines in FIG. 1 the display structure 10 is readily accessible at ground level for servicing or for changing or replacing a banner or display carried thereon.

The display in FIG. 2 is shown in retracted position in front elevation and comprises a banner or the like 16 that is stretched over a supported frame 18 (FIG. 4) that is housed within a frame 20 of inverted U-shape that is secured to the wall 12. As seen in FIGS. 2 and 3 the frame 20 has a horizontal upper member 22 and two vertically extending side members 24, the frame being open at its lower edge and surrounding the banner 16 and overlapping it at its upper and vertical side edges.

The frame 20 is secured to the wall 12 by suitable fasteners such as capscrews or bolts 26 (FIG. 4) passing through apertures in flanges 28 and 30 provided on the horizontal upper frame member 22 and side frame members 24 respectively. The upper frame member 22 has a horizontal top wall 32 and a vertical front wall 34 which as shown in FIG. 4 overlaps the upper edge of the banner frame 18 when the latter is in the retracted display position. Similarly, as best seen in FIG. 5, each of these vertical side members 24 has a first vertical wall 36 which lies at right angles to the flange 30 that lies against the building wall surface 12 and a second vertical wall 38 which lies parallel to the building wall and which has an extent sufficient to overlap the lateral edge of the banner frame 18.

As shown in FIG. 5, the front vertical wall 38 of the side frame member 24 is detachable with respect to the lateral vertical wall 36 thereof, being secured thereto by a flexible interengaging detent structure defined by a pair of tongues 40 associated with the front wall 38 and engageable with respective teeth 42 associated with the lateral vertical wall 36, the components having a degree of resilience to enable the tongues 42 to be passed over the teeth 40 in moving to and from the engaged position shown in FIG. 5.

Within the horizontal upper frame member 22 is housed a transverse horizontal shaft 44 (see FIGS. 4 and 8) which is rotatably mounted in bearings 46, 47 carried on the frame walls 36. The shaft 44 incorporates therein an electric motor 48 by means of which the shaft can be caused to rotate in its bearings. The motor 48 is of elongate small diameter form as available from Somfy Systems, 47 Commerce Drive, Cranbury, N.J. 08512, U.S.A. One end of the motor is fixedly secured into the bearing 47, the housing of the motor being rotatable relative to the fixed end and being secured by keys, rivets or screws (not shown) to the tubular shaft 44. Thus when the motor is energized it drives the shaft to rotate about the axis established by the fixed bearing 47 and the rotary bearing 46, the motor 48 being selectively driveable in opposite directions of rotation as required.

As best seen in FIGS. 8 and 9, a pair of spools 50 are mounted on the shaft 44 and fixed to rotate therewith, the spools being located at spaced positions adjacent opposite ends of the shaft 44. As shown clearly in FIG. 9, each of the spools 50 is of split construction comprising two approximately semi-cylindrical flanged shells 50.1, 50.2 the inner surfaces 50.3, 50.4 of which have a curvature that is matched to the curvature of the shaft 44. Confronting lugs 50.5, 50.6 on the half shells of the spool 50 are engaged by fasteners in the form of capscrews 50.7 which pass through clearance holes in the lugs 50.6 and engage in threaded holes in the lugs 50.5. It will be evident that by tightening the capscrews 50.7, the spool half shells 50.1, 50.2 can be securely fastened together and rigidly fixed in non-rotatable fashion with respect to the shaft 44.

The banner frame 18 comprises an upper horizontal frame member 52 the opposite ends of which are attached through adjustable eye bolts 54 to respective steel cables 56 which are wound onto the spools 50.

The banner frame further comprises a lower rectangular frame section 58 comprising a horizontal upper member 60 spaced above a horizontal lower member 62 and laterally spaced vertical side members 64, secured together to provide a rigid lightweight rectangular frame section. The frame section 58 is connected to the upper frame member 52 by adjustable lost-motion means. More specifically, adjacent each end of the frame member 52 a bolt 66 extends vertically through aligned clearance holes in the member 52 and also in the upper member 60, this bolt being fixed with respect to the member 52 by threaded engagement with a nut that is tightened against the underside of the member 52. The bolt 66 has an extended threaded shank 68 which passes through aligned clearance holes 70 in the horizontal upper member 60 and is engaged on the underside of the latter by a threaded nut 72.

From the foregoing it will be evident that the upper horizontal member 52 can be adjusted (to a degree) vertically with respect to the eye bolts 54 and the cables 56 by means of the nuts 55 in threaded engagement with the eye bolts on the underside of the member 52. By adjusting the position of these nuts along the threaded eye bolts 54 the position of the member 52 relative to the eye bolts can be adjusted vertically.

In a similar manner, adjustment of the position of engagement of the nuts 72 with respect to the threaded shanks 68 of the bolts 66 will limit the maximum separation between the rectangular frame section 58 and the upper horizontal frame member 52. As will be appreciated, since the bolt shanks 68 pass through clearance holes 70 in the horizontal frame member 60, the frame members 52 and 60 can be brought into closer relationship than the maximum separation (shown in FIG. 4) defined by the position of the nuts 72, this possibility being demonstrated by the position shown in FIG. 8. The position shown in FIG. 4 will occur when the banner 16 in the banner frame 18 is lowered as shown in FIG. 1 into contact with the ground surface 15. The ground surface will here support the lower frame section 58 so that continued rotation of the shaft 44 in a direction to lower the banner will result in a slight downwards movement of the upper member 52 to the relative position shown in FIG. 8.

From the above it will be appreciated that rotation of the shaft 44 will be effective through the cables 56 to raise or lower the banner frame 18 and that when the latter is moved away from the position resting in the ground as shown in FIG. 1, the rectangular frame section 58 will be suspended from the frame member 52 with the horizontal upper frame member 60 in engagement with the nuts 72 in the selected adjustment position of the latter. Thus the shaft 44 can be rotated to move the banner frame 18 between the elevated position shown in full lines in FIG. 1 and the lowered position shown in broken lines therein.

A track structure is provided to guide the banner frame 18 in its movement between the elevated and lowered positions. The track structure comprises telescopic track arrangements 74, 76 provided at respective ends of the banner frame. These track arrangements 74, 76 are substantially mirror images thereof and operate in an identical manner and therefore only one of them will be described.

As seen in FIG. 3, each telescopic track arrangement includes four track sections 78, 80, 82 and 84 respectively, these sections being telescopically extensible and retractable in the vertical direction to guide the banner 16 for movement between the retracted raised display position, and the lowered position shown in broken lines in FIG. 1. The top track sections 78 are fixed to the vertical walls 36 of the side frame member 24 by fasteners 86 as seen in FIG. 5, and the lower track sections 48 are likewise fastened to the side members 64 of the frame section 68 also as illustrated in FIG. 5.

As shown in FIGS. 5, 6 and 7, the track sections 78, 80, 82 and 84 are of complementary profile which profile has an extended dimension D (FIG. 5) in the vertical plane at right angles to the wall 12, this dimension being more than twice the dimension W (FIG. 5)of the track sections in a vertical plane parallel to the wall. While for reasons of strength and stability it is desirable to have the dimension D relatively large, the dimension W should be reduced as much as possible since this helps to reduce the width of the front wall 38 of the frame 20, this being desirable to increase the visual impact of the banner 16 which will be reduced by a frame that is unnecessarily bulky.

The top track section 78 and each of the second and third track sections 80 and 82 have profiles that define an oppositely directed pair of smoothly rounded longitudinal grooves 88 whereas the bottom track section and each of the intermediate track sections 80 and 82 have profiles that define a pair of oppositely directed elongate rounded ribs 90. As is evident from FIGS. 5, 6 and 7, the ribs 90 of one track section are arranged in close sliding engagement with the rounded grooves 88 of the next adjacent track section.

At least the interengaging sliding surfaces of the elongate grooves 88 and ribs 90 are of a low-friction material sufficient to ensure smooth extension and retraction movement of the telescopic track arrangement 74, 76 during manipulation of the device. However since there is minimal lateral loading between the telescoping track sections, there is no need to provide roller bearings or the like. The track sections 78, 80, 82, 84 are conveniently formed as extrusions in aluminum or aluminum alloy.

The extent to which adjacent ones of the track sections can be extended or retracted relative to one another is delimited by abutment pins. In the raised display position, see particularly FIG. 6, the track sections 78, 80, 82 and 84 are fully telescoped and fully retracted with respect to each other (FIG. 6) so that all are contained within the height of the frame 20. FIG. 6 shows that the track sections 78, 80, 82, 84 are successively slightly sorter in length. In the lowered position shown in broken lines in FIG. 1 the track sections are fully extended with respect to one another. However in the lowered position there is still a degree of overlap between each track section and each adjacent lower track section since this is necessary to maintain a degree of rigidity of the track arrangements 74, 76 against laterally directed forces which might arise, e.g. through wind action. Thus, a first detent 92 near the upper end of each of the track sections 80, 82 and 84 is positioned to contact a second detent 94 positioned in confronting relationship to the first detent at a position spaced above (e.g. by 10 to 12 inches) the lower end of the respective adjacent track section 78, 80 and 82. Thus when the track arrangements 74, 76 are extended upon lowering the banner 16, the degree to which the track sections can be extended relative to one another is limited by interengagement of the respective detents 92, 94. Furthermore, the detents 92 on the track sections 80, 82 project through the respective track section to act as lift detents. These lift detents are positioned to be engaged by the upper end of the next adjacent lower track section 82, 84 during raising of the banner 16. The arrangement of the detents 92 and 94 are shown more clearly in FIG. 7 which illustrates one of the intermediate track sections 80, 82. Each of these track sections has its upper end a detent 92 which has portions projecting on opposite sides of the track section, portion 92.1 being designed for engagement with the detent 94 of the next higher track section and portion 92.2 being positioned for engagement by the upper end of the next lower track section during raising of the banner. The uppermost track section 78 that is fixed in the frame 20 includes only the detent 94, and the lowermost track section 84 that is affixed to the frame of the banner 16 includes only the portion 92.2 of a detent 92.

From the position shown in FIG. 3, when the shaft 44 is rotated to raise the banner 16, the lower track sections 84 will move upwardly sliding freely within the intermediate track sections 82 until fully retracted whereupon the upper end 8 of the lower track section will engage the lift detent of the intermediate track section 82 so that these track sections will then travel in unison upon further lifting movement. Likewise, when the intermediate track sections 82 are fully retracted upwardly, their upper ends will engage the lift detent at the upper end of the respective next intermediate track section 80 causing the three lower track sections to move upwardly together. In the fully retracted position all the track sections are fully telescoped and the banner 16 is positioned within the frame 20.

The banner 16 itself may simply comprise a printed sheet of flexible material such as plastic having the desired information or pictorial or printed material thereon. The flexible banner 16 is connected along its upper edge to the upper horizontal frame member 52 and connected along its lower edge to the horizontal lower frame member 62, the connection being by means of fastener clips 102 which can be slid longitudinally into undercut channels 104, 106 in the horizontal frame members 52 and 62 respectively. The clips 102 have bendable arms 108 which can be passed through slits or apertures (not shown) along the upper and lower ends of the banner 16 and then folded over to securely retain the associated edge of the banner with respect to the channels 104 and 106.

The vertical dimension of the banner 16 is matched to the spacing between the channels 104 and 106 such that when the banner is raised off the ground, it is held taut by the weight of the rectangular frame section 58. To achieve this effect the positions of the nuts 72 along the threaded shanks 68 of the bolts 66 are adjusted so that the horizontal upper member 60 of the frame 58 does not engage and become seated on the nuts 72 until the banner 16 has been stretched taut. In this way it can be arranged that the flexible banner 16 does not exhibit any unsightly wrinkles or the like when it is raised to the display position. The stretching load on the banner can be varied both by adjusting the position of the nuts 72 and by adjusting the weight of the lower frame 58.

When the banner is to be removed or replaced, it is lowered from the display position to the ground position as indicated in FIG. 1. Upon reaching the ground position the banner can be relieved of stress by lowering the frame member 52 slightly with respect to the member 50, whereupon the banner can readily be detached from the fasteners 102.

Numerous alternative methods for achieving the objects of the invention will be apparent from a reading of the foregoing description.

The components of the frame 20 and the banner frame 18 and the telescopic tracks 74, 76 can be made of any suitable material. As with the tracks, the frames 22 and 18 could be made of aluminum or aluminum alloy members. Alternatively all of these components could be made in various compositions of plastics, glass fiber, fiber reinforced plastics etc.

The banner could of course be in forms other than one of flexible material as discussed above, and in the event that the banner constitutes a rigid sheet, then there would not be any requirement for a lost motion arrangement between the upper horizontal 52 and the lower frame section 58, and accordingly a unitary frame could be employed. Various means for attachment of the banner to the banner frame 18 other than the specific one described above are possible, e.g. by the use of cords, grommets, hooks, etc. Similarly, means other than the spools 50 and cables 56 could be employed to effect raising and lowering of the banner. For example a motor mechanism could be incorporated into the telescoping track arrangements 74, 76.

The dimensions of the banner 16 can be varied widely to suit numerous applications as can the length of the track arrangements and the extent to which they can raise and lower the banner. In the particular example illustrated the banner has a dimension of approximately 4 feet by 12 feet and is moved vertically between its upper and lowered positions through a distance of approximately 9 feet using track arrangements each having four track sections of an approximate length of 4 feet, each of the lower track sections 80, 82, 84 being capable of producing an extension of approximately 36 to 38 inches depending upon the minimum degree of overlap as determined by the detents 94. The number and configuration of the track sections can be modified to suit any particular installation. For particularly wide or heavy banners or other displays a third suspension cable and spool arrangement could be provided at an intermediate location in the length of the shaft 44.

Control of the display structure through operation of the motor can be arranged in any convenient way. Typically, a switch (not shown) will be provided on the exterior or interior of the building wall and will have three positions, one to effect rotation of the motor in a first direction to effect lowering of the structure, a second to effect rotation of the motor in the opposite direction to effect raising of the structure, and a third locked position wherein the motor is de-energized. Alternative means for control of the motor could be provided so that it can be done remotely, e.g. through the use of a microwave or radio link using well known techniques.

A simplified and preferred configuration of the display structure is shown in FIGS. 11 through 13. As in the previous embodiment, the display structure 110 includes a frame 120 mounted at an elevated location on a surface 112 of a wall. The frame 120 is similar to the frame 20 described in relation to the embodiment of FIGS. 1 to 10 having a horizontal top section, vertical side sections, and an open lower side. The top section and the side sections have flange like extensions 122, 124 respectively which overlap respective edges of the banner 116 when the latter is in its raised position.

As in the previous embodiment the banner 116 is moved between raised and lowered positions by means of flexible straps 156, (three of which are shown in FIG. 11) which are wound around spools 150 on a horizontal shaft 144 mounted between bearings 146 and 147 in the upper member of the frame 120. As before, the shaft 144 incorporates an electric motor by means of which it is driven in rotation in one direction or the other as desired.

The structure of the banner 116 is different in that there is no rectangular frame section, but rather only an upper horizontal frame member 160 and a lower horizontal frame member 162. However these frame members are not directly interconnected. The form of the frame members appears more clearly in FIG. 12 which shows these frame members to an enlarged scale as having identical profiles, formed as aluminium extrudates. Each frame member 160, 162 is of hollow box profile having along one edge a vertically arranged flange 164, 166 positioned opposite to a keyhole slot 168, 170 formed in the frame member profile and extending throughout the length thereof and having open ends at opposite ends of the frame member. As is clear from FIG. 12, each keyhole slot has a narrow slit-shaped entrance portion 172, 174 opening into an enlarged interior portion 176, 178.

The banner itself comprises a flexible rectangular sheet the upper and lower horizontal edges of which have enlargements 180, 182 sized to fit within the widened interior portions 176, 178 of the keyhole slots, but much too large to pass through the slot entrance portions 168, 170. These enlargements are suitably formed by wrapping each of the upper and lower marginal regions of the banner 116 to a rod-shaped member such as a plastic rope and bonding these marginal regions to the rod-shaped members, for example by heat welding.

Thus it will be seen that there is no direct connection between the upper and lower frame members 160, 162, but rather these are only linked through the material of the banner itself so that the lower frame member is in effect suspended from the upper frame member by the banner.

As seen in FIG. 11, at opposite ends of the lower frame member 162 there are laterally projecting pins 184, 186, these pins being integrally attached to the frame member 162.

At the lower end of each vertical part of the frame 120 in a location that is shielded by the side flange 124, there is a tensioning arrangement 190 for applying a loading tension to the banner 116 when the latter is in its raised deployed position to maintain the banner in taut condition. The tensioning arrangement is best seen in FIG. 13 as comprising a vertically oriented plunger 192 having a widened pocket structure 194 downwardly oriented at its lower end, the plunger being vertically slidable in a guide 196 that is fixedly attached near the lower end of a vertical wall at one side of the frame 20. The guide 196 defines a hollow interior channel with a closed upper end 198, and an open lower end through which the plunger 192 extends. Within this channel and compressed between the closed upper end 198 and the upper end 200 of the plunger is a coiled compression spring 202. It will be envisaged that the plunger 192 is movable vertically from the position shown in full lines in FIG. 13 compressing the spring 202 in the process, the force of the spring 202 varying in proportion to the extent of the upwards displacement of the plunger. In the position shown in FIG. 13 an abutment structure acting between the plunger 192 and the guide 196 prevents the former from passing completely out of the guide in the downwards direction.

The tensioning arrangement 190 is positioned at each side of the banner 160 to be engaged by the respective pins 184, 186 as the banner approaches its fully raised position, this being the position represented in full lines in FIG. 13 indicating the pin 186 moving upwardly into engagement with the pocket 194 of the plunger. From this position, further upwards movement of the banner will cause the pins 184, 186 to raise the respective plungers 192 against the force of their springs 202 until the position shown in broken lines in FIG. 13 is reached with the plungers 192 fully retracted. In this position, the force of each of the springs 202 acts on the lower frame member 162 through the respective pins 184 and 186 and applies a vertical tensioning force to the banner 116 to maintain it in taut condition so that it has no tendency to form folds or wrinkles. Furthermore, the force of the compression springs will prevent any tendency for the various parts to rattle or otherwise create noise.

The strength of the compression springs 202 and the range of travel of the plunger 192 can of course be selected to suit the overall dimensions of the display structure and the composition or material of the banner 116 itself. Typically the parts are dimensioned to accommodate a displacement of the plungers 192 at a magnitude of between about 5% and 10% of the height of the panel 116.

When the banner 116 is fully raised as discussed above the motor which drives the shaft 144 is in locked up condition and will hold the banner in position against the force of the springs without any slackening of the banner, until such time as the motor is actuated to rotate the shaft to lower the banner.

In situations where a supply of electrical power is not available, a mechanical means could be used to control movement of the structure, e.g. a clockwork mechanism or a spring system as used in conventional roller blinds.

It is also feasible to adapt the disclosed mechanism to provide banner display systems which operate in the reverse mode e.g. in which the operating mechanism is positioned at ground level, and this would be particularly suitable for providing banners and advertisements in situations such as exhibition halls. In this arrangement however it will evidently be necessary to include guide track structure as shown in FIGS. 1 to 10 and provide a floor mounted drive system whether mechanical, electrical or hydraulic to effect raising of the banner to the elevated display system.

Thus while specific embodiments of the invention have been disclosed in the foregoing and illustrated in the drawings, various modifications in the structure and components are possible and all such are intended to be comprehended within the scope of the appended claims.

1. A display structure comprising a panel carrier and a mechanism for controlled displacement of said panel carrier between vertically spaced extended and retracted positions, said mechanism comprising a raise/lower drive system for mounting on a support at an elevated location;
elongate flexible restraints connected to said drive system, and also connected to said panel carrier at laterally spaced locations thereon, said drive system being controllable selectively to retract or pay out said elongate flexible restraints to effect movement of said panel carrier between said deployed and retracted positions;
a panel display frame for mounting on said support at an elevated location and configured to receive said panel carrier in the retracted position thereof and to display a panel supported on the panel carrier.

2. A display structure as claimed in claim 1 for use in combination with a flexible display panel that can be connected to said panel support, said display structure including an elongate horizontal lower frame member for attachment to a lower edge of said panel so as to be suspended from said panel support by said display panel;
said horizontal lower frame member having projecting end sections that in use are movable into engagement with said panel display frame as the panel approaches the retracted position;
resiliently displaceable members being provided and located on said display frame to be compressed in use by said projecting end sections as the panel carrier approaches the retracted position so as to apply a vertical stretching force to said display panel in the retracted position.

3. A display structure as claimed in claim 2 wherein said end sections project laterally beyond opposite ends of said display panel.

4. A display structure as claimed in claim 2 wherein said resilient displaceable members are configured to be resiliently displaced by a distance of between 5% and 10% of the height of said flexible display panel to maintain a stretching force on said flexible display panel when deployed in the retracted position thereof.

5. A display structure as claimed in claim 2 including means for guiding said panel support during upward movement thereof so that it passes freely upwardly above said resiliently displaceable members.

6. A display structure as claimed in claim 1 wherein said panel carrier comprises an elongate horizontal beam of constant profile, said profile including a downwardly open keyhole slot, said slot having an entrance portion that is of a width sufficient to accommodate the thickness of the panel, said entrance portion leading to an enlarged interior portion sized to receive an enlarged marginal edge of the panel, said entrance portion being sized to prevent passage of said enlarged marginal portion vertically out of said keyhole slot.

7. A display structure as claimed in claim 6 wherein said horizontal lower frame member is of similar configuration to said panel carrier but of inverted orientation.

8. A display structure as claimed in claim 7 wherein each of said panel carrier and said horizontal lower frame member is of extruded aluminium construction.

9. A display structure as claimed in claim 7 in combination with a banner having upper and lower marginal edges which are thickened by incorporating therein a generally cylindrical plastic member that is bonded directly to the material of the panel.

10. A display structure comprising a panel carrier and a vertically extensible mechanism for controlled displacement of the panel carrier between vertically spaced raised and lowered positions, comprising:
a pair of guide tracks each formed by at least first and second elongate linear track sections, each first track section being telescopically extensible with respect to the corresponding second track section;
said panel carrier being positioned in a vertically orientation between said extensible first track sections;
each said guide track being adapted for anchoring to a support to extend vertically thereon for guidance of said first track sections during movement of said panel carrier between the raised and the lowered positions.

11. A structure as claimed in claim 10 including in each guide track at least one intermediate track section located between said first and second track sections and being telescopically arranged with respect to each of them.

12. A structure as claimed in claim 10 wherein said guide tracks are horizontally spaced and connected to opposite ends of said panel carrier, each said first track section having a profile that is complementary to that of the corresponding second track section, said profiles being in close sliding engagement with each other, wherein in horizontal cross-section each said profile is horizontally elongate in a direction at right angles to said panel structure.

13. A structure as claimed in claim 12 wherein said panel structure comprises an overhead door which in the lowered condition thereof closes a door opening and in the raised position uncovers the door opening.

14. A structure as claimed in claim 12 wherein said panel carrier is adapted to carry a display sign which in the raised position is oriented vertically at an elevated location.

15. A display structure as claimed in claim 10 in combination with a mounting frame that is adapted for securing the display structure to a vertical support surface, said mounting frame having an outline that is similar to that of the panel carrier and that defines with the support surface a vertical pocket that is open along its lower side and into which the panel carrier is retracted in said raised position.

16. A structure as claimed in claim 10 further comprising a powered drive that is coupled to said panel carrier and is operative to effect vertical movement thereof in said guide tracks against the force of gravity.

17. A display structure as claimed in claim 15 wherein said mounting frame has spaced vertical limbs extending downwardly from the ends a horizontal limb, each said limb having an extension which overlies and screens a corresponding edge region of the panel carrier when the latter is in its raised position.

18. A display structure as claimed in claim 16 wherein said powered drive comprises a driven shaft that is positioned within a horizontal top member of the mounting frame and which is connected through cables to opposite ends of panel carrier such that rotation of the shaft in one direction will permit the panel carrier to descend under the force of gravity, and rotation of the shaft in the opposite direction will cause the panel carrier to ascend.

19. A display structure as claimed in claim 12 wherein each said guide track comprises at least three telescopic track sections which are slidably inter-connected and have mating profiles which are horizontally compact in a vertical plane that is parallel to said panel carrier and that are horizontally extended in a vertical plane that lies at right angles to said panel carrier.
